(19) United States
(12) Patent Application Publication
(10) Pub. No.: US 2007/0089501 A1
(43) Pub. Date: Apr. 26, 2007

(54) Method for monitoring exhaust gas condensates

(76) Inventor: Dennis L. Endicott, Hanna City, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/239,120

(22) Filed: Sep. 30, 2005

(51) Int. Cl. G01M 19/00

(52) U.S. Cl. 73/118.1

(57) ABSTRACT

A method for monitoring exhaust gas condensates to identify corrosive conditions is provided. The method includes producing an exhaust gas stream by combustion in an engine and supplying the exhaust gas stream to an exhaust system. The exhaust gas stream may be cooled to form a condensate. The conductivity of the condensate may be measured, and the conductivity measurement may be normalized to a predetermined temperature.

### TECHNICAL FIELD

This disclosure pertains generally to methods and systems for monitoring engine exhaust gases, and more specifically, to methods and systems for identifying corrosive exhaust gas conditions.

### BACKGROUND

Currently, diesel fuels often contain sulfur and other substances, which may be converted to potentially corrosive and environmentally unfriendly by-products. Consequently, there has been a consistent demand for lower-sulfur content in diesel fuels. However, despite efforts to reduce diesel sulfur content, corrosion of exhaust system components due to acidic sulfur by-products continues to be a problem. Further, batch-to-batch variation in fuel sulfur content and improper fuel selection may still be a problem even after fuels with very low sulfur content become routinely available.

Diesel sulfur may be converted to sulfuric acid during engine and exhaust system operation. The sulfuric acid may condense downstream in the exhaust system, thereby producing an acidic condensate. Acidic condensates are a major cause of exhaust system corrosion. Therefore, improved methods for monitoring exhaust gas condensates to identify potentially damaging conditions are needed.

One method for monitoring corrosion in diesel engines is disclosed in U.S. Pat. No. 4,196,057, issued to May on Apr. 1, 1980 (hereinafter the '057 patent). The '057 patent provides a cold end corrosion rate measurement probe, which includes a temperature measuring device such as a thermocouple. The probe further includes a cooling jacket, which can bring a monitored gas to its dew point. The dew point may be indicated by an increased conductivity across two electrodes. Measurement of corrosion rate and accompanying dew point can be correlated with exhaust gas sulfur trioxide concentration.

Although the '057 patent may provide a suitable method for monitoring corrosion, the method of the '057 patent may have several drawbacks. For example, the method of the '057 patent may require a corrosion probe, such as a polarization admittance instantaneous rate probe. In addition, dew point measurement according to the method of the '057 patent requires a conductivity sensor, a cooling system, and a temperature monitoring device; and although the dew point may be correlated with exhaust gas sulfur trioxide concentrations, it may not accurately reflect condensate acidity over a range of temperatures.

The present disclosure is aimed at overcoming one or more of the shortcomings of the prior art corrosion monitoring systems.

### SUMMARY OF THE INVENTION

One aspect of the present disclosure includes a method for monitoring exhaust gas condensates to identify corrosive conditions. The method includes producing an exhaust gas stream by combustion in an engine and supplying the exhaust gas stream to an exhaust system. The exhaust gas stream may be cooled to form a condensate. The conductivity of the condensate may be measured, and the conductivity measurement may be normalized to a predetermined temperature.

A second aspect of the present disclosure includes an exhaust system condensate monitor. The condensate monitor may include a sensor configured to measure the conductivity of an exhaust gas condensate, a temperature sensor, and a control unit configured to calculate a temperature normalized condensate conductivity.

A third aspect of the present disclosure includes an exhaust corrosion control system. The system may include an exhaust gas cooling system, an exhaust gas condensate conductivity sensor disposed downstream of the exhaust gas cooling system, and an electrical control unit configured to receive signals representing conductivity measurements from the condensate conductivity sensor.

### BRIEF DESCRIPTION OF THE DRAWINGS

FIG. 1 provides a schematic diagram of an engine and exhaust system including condensate monitoring sensors, according to an exemplary disclosed embodiment.

FIG. 2 provides a flowchart of a method for monitoring an exhaust gas condensate, according to an exemplary disclosed embodiment.

FIG. 3 provides a schematic diagram of an engine and exhaust system including condensate monitoring sensors, according to another exemplary disclosed embodiment.

FIG. 4 illustrates the correlation between exhaust gas condensate conductivity and pH, according to an exemplary disclosed embodiment.

FIG. 5 illustrates the relationship between exhaust gas condensate conductivity and pH under variable engine operating conditions.

FIG. 6 illustrates the relationship between exhaust gas condensate conductivity and pH using variable after-treatment systems and fuel sulfur contents.

### DETAILED DESCRIPTION

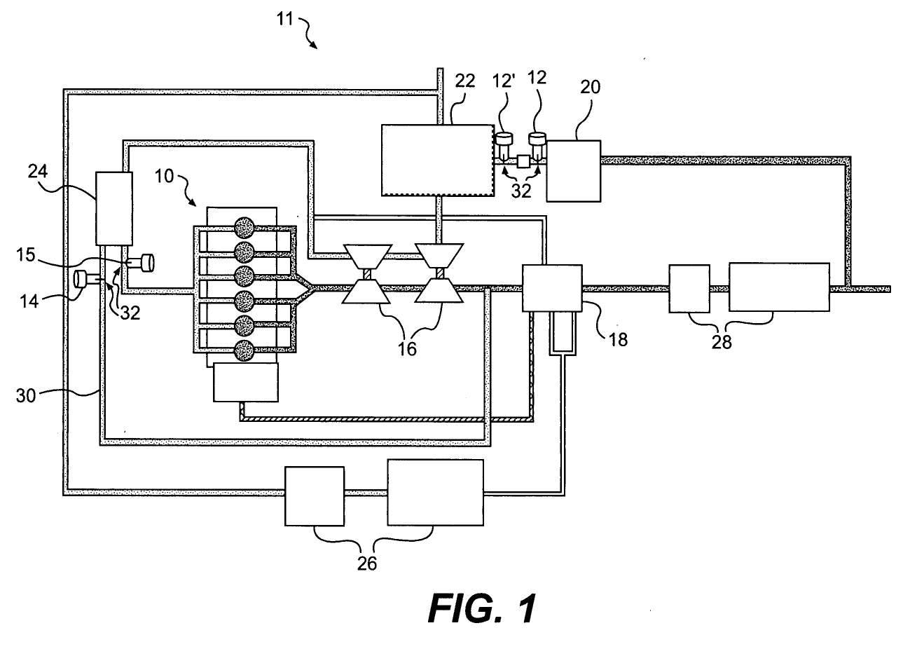

FIG. 1 provides a schematic diagram of an engine 10 and exhaust system 11 including condensate monitoring sensors, according to an exemplary disclosed embodiment. As shown, engine 10 and exhaust system 11 may include a diesel engine and exhaust system, as may be used with a variety of different trucks, heavy equipment or other machines. For example, engine 10 and exhaust system 11 may be used on highway trucks, off-highway trucks, cranes, bull-dozers, generator sets, railroad equipment, and/or any other suitable machine. Further, the design of engine 10 and exhaust system 11 may be selected based on the desired application, and any suitable engine 10 and exhaust system 11 may be selected.

Engine 10 and exhaust system 11 may include a variety of suitable components. For example, as shown in FIG. 1, exhaust system 11 may include one or more condensate conductivity sensors 12, 12′, 14, 15. Exhaust system 11 may further include a number of other exhaust system components including, for example, one or more turbo-chargers 16, an auxiliary regeneration device 18, an exhaust cooler 20 (e.g. an exhaust-gas regeneration cooler or other suitable exhaust cooler), an exhaust-gas regeneration device 22, an air cooler 24 (e.g. and air-to-air after cooler or other suitable air cooler), an air-compressor system 26, and/or one or more aftertreatment system components 28.

The one or more condensate conductivity sensors 12, 12′, 14, 15 may be located at a variety of suitable exhaust system locations. Generally, sensors 12, 12′, 14, 15 may be positioned at any location where an exhaust gas condensate may be expected to form. For example, as shown in FIG. 1, two sensors 12, 12′ are positioned downstream of exhaust cooler 20. Further, in some embodiments, second sensor 14 may be positioned downstream of air cooler 24 and within a condensate drain line 30. Alternatively or additionally, a third sensor 15 may be positioned in an exhaust passage downstream of air cooler 24.

It should be noted that sensors 12, 12′, 14, 15 may be positioned at other locations where a condensate may form. In one embodiment, condensate sensors may be positioned downstream of a turbocharger 16 or other forced induction system. Any suitable location may be selected for selected conductivity sensors 12, 12′, 14, 15.

Sensors 12, 12′ 14, 15 may include a number of suitable sensor types. In one embodiment, sensors 12, 12′, 14, 15 may be configured to measure the conductivity of an exhaust gas condensate. In some embodiments, the conductivity may be measured as the specific conductivity, which may be defined as the reciprocal of the specific resistance of a solution measured between two electrodes 1 cm² in area and 1 cm apart.

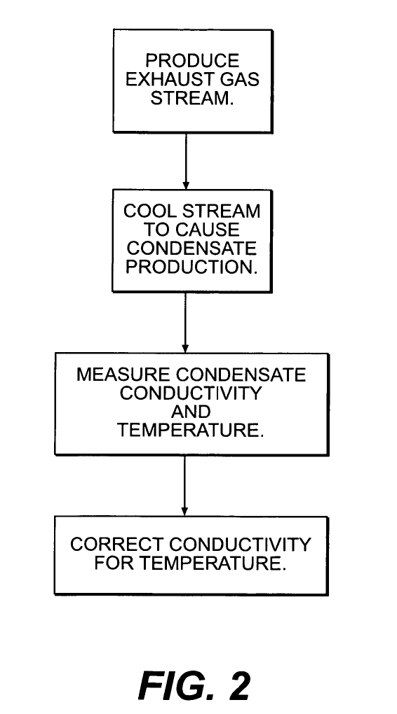

FIG. 2 provides a flowchart of a method for monitoring an exhaust gas condensate, according to an exemplary disclosed embodiment. In this embodiment, an exhaust gas stream is first produced by engine 10 and delivered to the exhaust system 11. The exhaust gas stream may be cooled using a variety of different coolers, as described above. Under some engine operating conditions, a condensate may form within the exhaust system. Therefore, if a condensate does form, it may be desirable to measure the condensate conductivity to determine if the condensate may be corrosive. It should be noted that condensates are not generally produced intentionally, but may form as a result of cooling exhaust streams having certain compositions. For example, exhaust streams having higher sulfur oxides may condense at lower temperatures than exhaust streams with low sulfur oxide conditions. However, it may still be desirable to cool an exhaust gas stream in order to improve engine operation (i.e. produce better fuel efficiency, power output, and/or emissions control).

A variety of suitable sensor designs may be selected for sensors 12, 12′, 14, 15. For example, suitable sensors may be produced from two or more electrodes. A voltage or current may be produced between the electrodes, and the resistivity (inverse of conductivity) may be measured. In some embodiments, the sensor may be configured to measure the specific conductivity of a condensate. Alternatively, the specific conductivity of a condensate may be calculated. For example, a specific conductivity may be calculated by multiplying a measured conductivity between two electrodes by a cell constant. Generally, a cell constant will equal the distance between the electrodes divided by the electrode area.

It should be noted that other suitable electrode configurations may be selected. For example, in some embodiments, the sensor may include an array or arrays of electrodes. Suitable electrode arrays may be produced using a variety of different materials processing techniques, such as photolithography. Electrode arrays may be selected for a number of purposes. For example, an electrode array may allow redundant electrode pairs to be used to ensure measurement accuracy. Further, electrode arrays may also include additional sensors (e.g. oxygen sensors and/or NOx sensors). Any suitable electrode design may be selected.

The conductivity of a solution may be affected by temperature, and the temperature of an exhaust system may fluctuate. Therefore, in some embodiments, it may be desirable to normalize a measured condensate conductivity to a predetermined temperature. For example, in some embodiments, it may be desirable to normalize an exhaust condensate conductivity to 25° C., but any suitable temperature may be selected, as long as measurement to measurement comparisons can be made. Normalize the conductivity measurement may facilitate condensate monitoring at two or more different temperature, or over a range of temperatures.

A variety of suitable methods are available to normalize conductivity measurements to compensate for the effects of temperature fluctuations. For example, in some embodiments, temperature compensation may be based on measured or estimated condensate chemical compositions. For example, for some sensors, conductivity may be normalized using the following formula:
Normalized Conductivity=Measured Conductivity/(1+x(T−T₁)

where x is a constant related to the solution being measured, T is the temperature of the measured conductivity, and T₁ is the temperature to which the conductivity is normalized. Alternatively, normalization may be accomplished by assuming that a solution contains a certain concentration of ions and to provide an appropriate temperature correction. For example, for a given condensate composition, a conductivity adjustment equal to a certain value or percentage may be made for each degree of temperature deviation. It should be noted that other methods may be used to normalize the temperature, and any method that allows suitable comparison between conductivity measurements may be selected.

In some embodiments, sensors 12, 12′, 14, 15 may also include a temperature sensor 32 to facilitate compensation for temperature variations. For example, some conductivity sensors 12, 12′, 14, 15 may include a thermocouple (as shown in FIG. 1) positioned adjacent to one or more electrodes and configured to measure a condensate temperature. Alternatively, temperature sensor 32 may be positioned nearby sensors 12, 12′, 14, 15 to facilitate measurement of exhaust gas or condensate temperature.

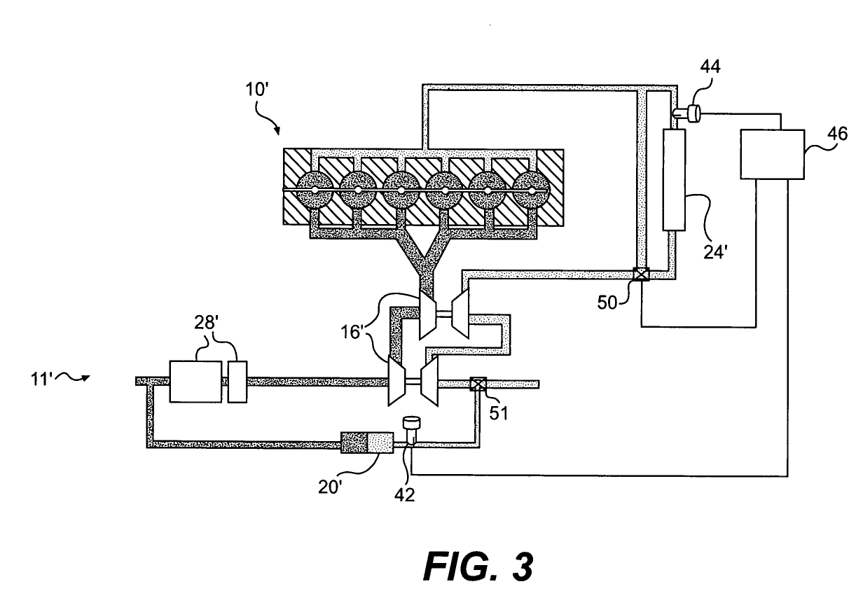

FIG. 3 provides a schematic diagram of an engine 10′ and exhaust system 11′ including condensate monitoring sensors 42, 44, according to another exemplary disclosed embodiment. As shown in FIG. 3, exhaust system 11′ may further include one or more turbochargers 16′, an exhaust cooler 20′, an air cooler 24′ or air-to-air heat exchanger, and an aftertreatment system 28′. In addition, sensors 42, 44 may be connected with a control module 46, which may be configured to store conductivity measurements and/or change machine operational parameters in response to certain measurements.

Control module 46 may include a variety of suitable designs. For example, control module 46 may include a machine electrical control module, which may control a variety of different machine operations, including engine operation, exhaust system operation, and/or any other machine operating parameter. Alternatively, control module 46 may be dedicated to monitoring exhaust gas and/or condensate conditions. Further, as shown, control module 46 is a separate component, but control module 46 may be integrated with one or more conductivity sensors 12, 12′, 14, 15.

In some embodiments, control module 46 may be configured to receive signals indicative of conductivity measurements from sensors 42, 44. In addition, control module 46 and/or sensors 42, 44 may convert the signal into a value indicative of condensate composition. For example, in one embodiment, control module 46 and/or sensors 42, 44 may convert the conductivity measurement into a pH measurement. Alternatively, the conductivity measurement may be converted into a fuel sulfur content measurement, which may be related to condensate pH. In addition, the conductivity measurement may be correlated with the concentration of other exhaust gas chemicals, and control module 46 and/or sensors 42, 44 may be configured to provide a measurement of other exhaust gas chemical concentrations.

Control module 46 may further be configured to store signals from sensors 42, 44. For example, in some embodiments, control module 46 may store measurements continually or at predetermined intervals. Alternatively, control module 46 may be configured to store signals, which may be indicative of abnormal conditions, such as high fuel sulfur content, low condensate pH, and/or other factors that may increase the corrosive potential of exhaust condensates. In addition, control module 46 may be configured to monitor and/or store other factors related to abnormal measurements. These factors may include, for example, the duration of abnormal measurements, the date of occurrence, engine operating parameters, temperature, and/or the presence or concentration of other exhaust gas chemical species.

In some embodiments, sensors 42, 44 and/or control module 46 may be configured to identify abnormal conductivity measurements and to store information indicative of the occurrence or severity of the abnormality. For example, in some embodiments, an abnormal measurement may be defined as any conductivity measurement above a predetermined threshold. The predetermined threshold may be selected based on a number of factors. For example, the threshold may be based on engine and exhaust system conditions such as temperature, speed, and/or power output. The threshold may also be selected based on an acceptable level of corrosive potential, which may be determined by the corrosion resistance of exposed machine parts, cost of machine components, desired application, and/or any other suitable factor.

Further, in some embodiments, control module 46 may be configured to change one or more machine parameters in response to abnormal conductivity measurements. For example, control module 46 may be configured to change machine operating parameters to reduce condensate formation. Condensate formation may be affected by a variety of factors, including temperature. In some embodiments, control module 46 may be configured to increase the exhaust system temperature at one or more locations to reduce condensate formation. Exhaust system temperature may be increased by a variety of methods including, for example, increasing the combustion temperature of an engine, heating the exhaust gas stream using a burner or other heating element, controlling the operation of air or exhaust coolers, controlling the operation of turbochargers, and/or any other suitable method.

In other embodiments, control module 46 may be configured to divert the flow of an exhaust gas stream away from exhaust system components in response to abnormal conductivity measurements. For example, as shown in FIG. 3, control module 46 may control the operation of a flow valve 50, which may be configured to divert flow away from air cooler 24′ to reduce condensate formation in air cooler 24′. Additionally, an exhaust mixing valve 51 may be configured to decrease or shut down exhaust flow to the system intake air, thereby reducing condensate formation in other system components. Control module may also divert flow from any other exhaust system component in order to reduce condensate formation or to prevent condensate contact with components that may be especially susceptible to corrosion or would be costly or difficult to replace. Further, any suitable valves and/or other components may be added to control air flow at selected locations within the system.

In still other embodiments, control module 46 may provide a signal to warn of the abnormal condensate condition. For example, control module may cause an audible or visual signal to be produced, thereby warning a machine operator or other suitable person that a potentially corrosive condition exists.

It should also be noted that condensate conductivity may be affected by a number of chemical species. For example, as noted, condensate conductivity may be affected by the presence of one or more acidic species, including sulfuric acid or nitric acid. In addition, condensate conductivity may be affected by the presence of various non-acidic species including, for example, sodium ions and/or chloride ions. However, since any ionic species will generally increase condensate conductivity, and since chloride and other ions may also contribute to exhaust system corrosion, conductivity measurement changes due to non-acidic ions may also be monitored to assess the corrosive potential of a condensate.

In addition, although simplified engine and exhaust system designs are shown, a variety of suitable engine and exhaust systems may be selected. For example, any suitable engine size, shape, and/or configuration may be selected. Further, aftertreatment systems 28, 28′ may include a variety of different designs. Suitable aftertreatment systems may include particulate filters and/or one or more catalysts having a variety of different structures, washcoat compositions, and/or catalytic specificities. In addition, suitable engines and exhaust systems may include a variety of other sensors, valves, additive supply devices, catalyst, filters, and/or other desired engine or exhaust system components.

### EXAMPLE 1

### Correlation Between Condensate Conductivity and pH

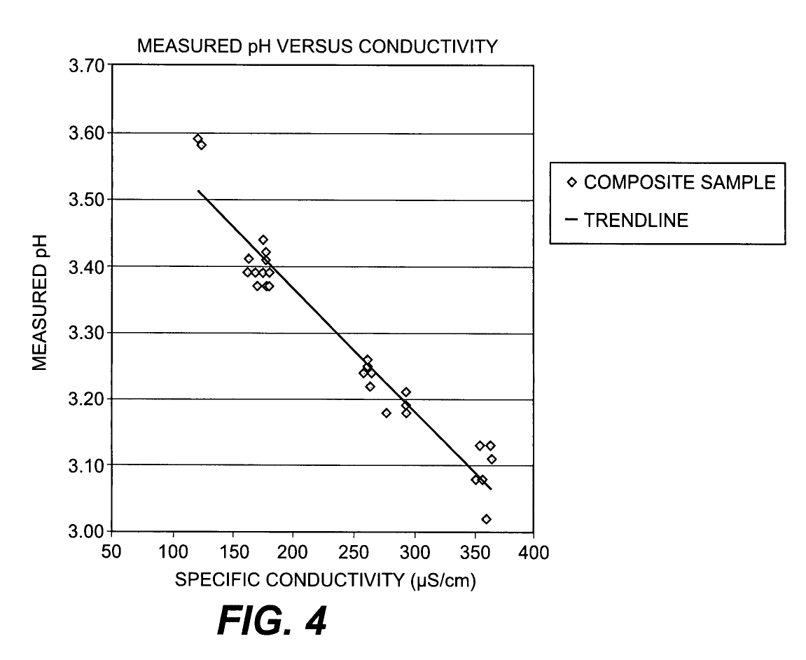

FIG. 4 illustrates the correlation between exhaust gas condensate conductivity and pH. All condensate samples were collected at four hour intervals using a Caterpillar C13 engine running repetitive ET-89 cycles. The condensate was produced within an air-to-air aftercooler and collected at a position corresponding to sensor 15 of FIG. 1. Sample pH was measured using a commercially available pH probe. Specific conductivity was measured using a Fisher Scientific Accumet Excel XL30 conductivity meter.

FIG. 4 illustrates a linear relationship between condensate conductivity and pH under consistent engine operating conditions, fuel sulfur content, aftertreatment system configuration, and exhaust system location. Further, as noted above, the relationship between condensate conductivity and pH may be affected by a variety of different factors, and changing any of these factors may affect conductivity measurements.

### EXAMPLE 2

### Measurement of Condensate Conductivity Under Variable Engine Operating Conditions

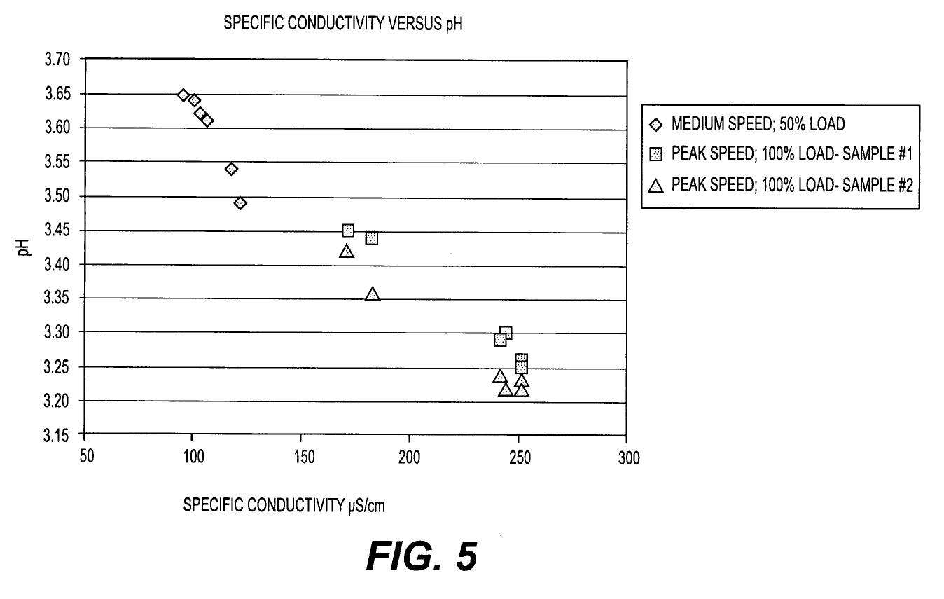

FIG. 5 illustrates the relationship between exhaust gas condensate conductivity and pH under variable engine operating conditions. All samples were collected from an exhaust gas condensate produced using a Caterpillar C13 engine with a diesel fuel containing about 15 parts-per-million (ppm) sulfur. Multiple samples were collected at four hour intervals using two engine operating conditions: (1) medium torque speed with 50% load, and (2) peak torque speed with 100% load. For the peak torque, 100% load conditions, two sample sets were taken on separate dates, and both sets are shown.

As shown, condensate conductivity is higher, and condensate pH is lower using a higher-speed and a greater-load. The difference in condensate conductivity and pH under variable operating conditions may be due to the presence of additional acidic species, such as nitric oxides within the condensate. In addition, it should be noted that FIG. 5 illustrates condensate conductivity variability for two samples collected on different dates but with similar operating conditions (i.e. peak torque, 100% load). This variability may be due to changes in environmental conditions, such as humidity or temperature.

### EXAMPLE 3

### Correlation Between Condensate Conductivity and Fuel Sulfur Content Using Variable After-treatment Systems

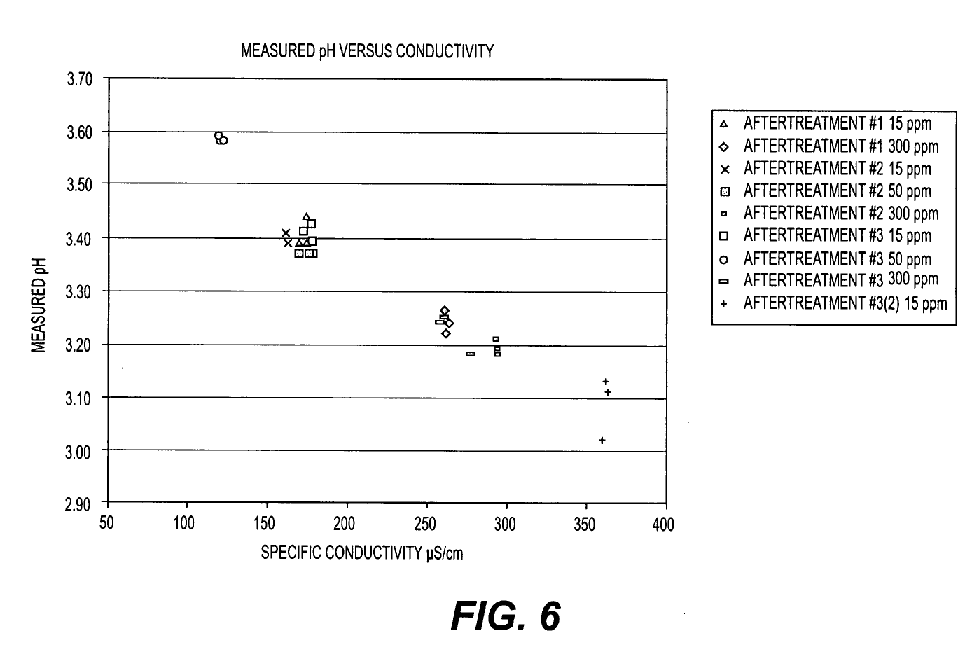

FIG. 6 illustrates the relationship between exhaust gas condensate conductivity and pH using variable aftertreatment systems and fuel sulfur contents. Again, all samples were collected at four hour intervals from a Caterpillar C13 engine at a location corresponding to sensor 15 of FIG. 1. Three aftertreatment configurations were used. Aftertreatment System #1 included a platinum-containing diesel oxidation catalyst upstream of a bare, non-catalyzed ceramic diesel particulate filter. Aftertreatment System #2 included a diesel particulate filter with a platinum washcoat. Aftertreatment System #3 included a diesel particulate filter with a platinum-palladium washcoat. Fuels containing about 15 ppm sulfur, about 50 ppm sulfur, and about 300 ppm sulfur were used.

As shown in FIG. 6, there is a strong correlation between condensate pH and conductivity for all samples. Further, sample conductivity tends to increase with increasing fuel sulfur content, demonstrating the effect of sulfuric acid ionic components on condensate conductivity. It should be noted that several samples using Aftertreatment System #3 with 15 ppm sulfur fuel had an unusually high conductivity. This is believed to be due to a sampling error or fuel mix up.

### INDUSTRIAL APPLICABILITY

This disclosure provides a system and method for identifying potentially corrosive conditions in engine exhaust systems. The method includes monitoring exhaust gas condensate conductivity.

Acidic exhaust gas condensates are a major cause of exhaust system corrosion, but there is currently no suitable method for direct, on-line measurement of exhaust gas condensate pH. However, exhaust gas condensate conductivity is correlated with the concentration of ionic charge carriers present in the condensate. Further, since most condensate charge carriers are provided by acidic species, such as sulfuric acid and/or nitric acids, condensate conductivity may be correlated with condensate pH. Therefore, the present disclosure provides a rapid and reliable method for monitoring condensate acidity by on-line measurement of condensate conductivity, thereby providing a method for assessing the corrosive potential of exhaust system condensates. The method can be used for on-line monitoring in diesel engine exhaust systems or any other suitable exhaust system, which may include acidic chemical species.

The present disclosure also provides systems for recording abnormal condensate conductivities and/or preventing exhaust system damage due to transient, low condensate pH. Abnormally low condensate pH may occur due to intentional or accidental use of certain fuels containing higher than desired sulfur concentrations. If an abnormal, potentially damaging condition is detected, the occurrence of the condition may be stored by a machine electrical control unit. In the event of failure of one or more exhaust system components, the record of abnormal condensate conductivity may assist in diagnosis of failure mode, servicing of warranties, and/or any other suitable purpose. In addition, during periods of potentially damaging condensate pH, the exhaust gas stream may be altered to prevent condensate formation. Additionally, the exhaust gas stream may be shunted away from susceptible or expensive exhaust system components, thereby preventing costly repairs or exhaust system failure.

It should be noted that condensate conductivity may be correlated with a variety of different charge carrier concentrations. For example, operation of engines near sea water, may allow certain amounts of chloride from sea salts to enter the exhaust system. The chloride may provide an additional charge carrier, which will decrease condensate conductivity as if the condensate were more acidic. Since charge carriers, such as chloride, can also be damaging to exhaust system components, the system of the present disclosure may also be used to identify corrosive conditions caused by non-acidic ionic species.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A method for monitoring exhaust gas condensates to identify corrosive conditions, comprising:
producing an exhaust gas stream by combustion in an engine;
supplying the exhaust gas stream to an exhaust system;
cooling the exhaust gas stream to form a condensate;
measuring a conductivity of the condensate; and
normalizing the conductivity measurement to a predetermined temperature.

2. The method of claim 1, wherein measuring the conductivity of the condensate includes measuring the specific conductivity of the condensate.

3. The method of claim 1, further including determining the pH of the condensate based on the conductivity of the condensate.

4. The method of claim 1, further including determining a sulfur content of a fuel used for combustion in the engine.

5. The method of claim 1, further including determining if the conductivity is above a predetermined upper limit.

6. The method of claim 5, further including recording the occurrence of a conductivity measurement above the predetermined upper limit in a data storage system.

7. The method of claim 6, further including recording the value of the conductivity that is above the predetermined upper limit.

8. The method of claim 6, further including recording the amount of time that the conductivity is above the predetermined upper limit.

9. The method of claim 5, further including providing a warning signal to indicate that the conductivity is above the predetermined upper limit.

10. The method of claim 5, further including ceasing production of the condensate if the condensate conductivity is above the predetermined upper limit.

11. The method of claim 10, wherein ceasing production of the condensate includes operating an engine at a higher temperature to prevent formation of a condensate.

12. The method of claim 10, wherein cooling of the exhaust gas stream is stopped to prevent condensate formation.

13. An exhaust system condensate monitor, comprising:
a sensor configured to measure the conductivity of an exhaust gas condensate;
a temperature sensor; and
a control unit configured to calculate a temperature normalized condensate conductivity.

14. The sensor of claim 13, wherein the sensor is configured to measure the specific conductivity of the exhaust gas condensate.

15. The sensor of claim 13, wherein the sensor includes at least two electrodes.

16. The sensor of claim 13, wherein the sensor includes an array of electrodes.

17. The sensor of claim 13, wherein the sensor is disposed downstream in an exhaust passage from a cooling system.

18. An exhaust corrosion control system, comprising:
an exhaust gas cooling system;
an exhaust gas condensate conductivity sensor disposed downstream of the exhaust gas cooling system; and an electrical control unit configured to receive signals representing conductivity measurements from the condensate conductivity sensor.

19. The corrosion control system of claim 18, wherein the electrical control unit is configured to store the signals representing conductivity measurements.

20. The control system of claim 18, wherein the condensate conductivity sensor is configured to measure the specific conductivity of the exhaust gas condensate.

21. The corrosion control system of claim 18, wherein the electrical control unit is configured produce a change in a machine operating parameter if the conductivity is above a predetermined upper limit.

22. The corrosion control system of claim 21, wherein the change in the machine operating parameter includes increasing the temperature of an exhaust gas stream to prevent condensate formation.

23. The corrosion control system of claim 21, wherein the change in the machine operating parameter includes controlling a flow of an exhaust gas stream to prevent condensation formation on one or more components of a machine exhaust system.
